(19) United States
(12) Patent Application Publication
(10) Pub. No.: US 2010/0299288 A1
(43) Pub. Date: Nov. 25, 2010

(54) RULE-BASED VOCABULARY ASSIGNMENT OF TERMS TO CONCEPTS

(76) Inventor: JOCHEN GRUBER, Wiesloch (DE)

Correspondence Address: SAP AG, 3410 HILLVIEW AVENUE, PALO ALTO, CA, 94304, US

(21) Appl. No.: 12/468,087

(22) Filed: May 19, 2009

(51) Int. Cl. G06F 15/18; G06N 5/02

(52) U.S. Cl. 706/12; 706/47

(57) ABSTRACT

Methods and systems are described that involve rule-based vocabulary assignment of terms to concepts. Instead of assigning individual terms to each concept in a conceptualization of a domain, such as taxonomy, ontology, and so on, production rules are defined and assigned to each concept. The production rules produce at least one term to name a concept by referring to semantically related concepts to this concept. The production rules may include context information specifying the context where a given rule is valid. The methods and systems can be used to improve search capabilities for entities by enabling easier annotation of large conceptualizations. Further, the methods and systems can improve user experience by allowing context specific naming of entities.

### TECHNICAL FIELD

Embodiments of the invention generally relate to the software arts, and, more specifically, to methods and systems for rule-based assignment of terms to concepts.

### BACKGROUND

In the field of computing, a concept is a precise definition of the term it is assigned to. A term in a given database, such as a lexical database, may have other terms in the database that it is related to as synonyms (i.e., equivalent in meaning), homonyms (i.e., pronounced or spelled in the same way), hypernyms (i.e., generalization of the term also referred to as a super concept), and hyponyms (i.e., specialization of the term) of the term. Concepts provide semantic identity to the terms in the database by defining their meanings and help differentiate terms clearly from their homonyms, hypernyms or hyponyms. A term in the database may have more than one meaning and thus may have more than one concept assigned to it. A single concept may also be assigned to two or more terms in the database.

A formal representation of a set of concepts within a domain and the relationships between these concepts is known as ontology. The ontology provides a shared vocabulary, which can be used to model a domain—that is, the type of the objects and/or concepts that exist and their properties and relations. Domain ontology models a specific domain. It represents the specific meaning of terms as they apply to that domain. Conceptualizations of domains such as taxonomies and ontologies are used to avoid natural language (NL) ambiguities such as synonyms and homonyms. It is much easier to process taxonomies and ontologies electronically than NL texts. Particularly, the taxonomies and ontologies serve as references for assigning semantics to entities in software systems such as entries in databases, objects in software programs, and so on.

### SUMMARY

Methods and systems are described that involve rule-based assignment of terms to concepts. In one embodiment, the method includes receiving a hierarchically organized structure of concepts, wherein each concept is assigned to at least one term. A concept and a plurality of sub-concepts semantically depending from the concept are identified in the hierarchically organized structure. Further, a production rule is created with a head and a body, the body representing a logical rule and the head representing a set of terms produced by the logical rule. Finally, the production rule is applied to all terms assigned to the concept.

In one embodiment, the system includes a hierarchically organized structure of objects, wherein each object is represented with a concept, the concept being assigned to at least one term. The system also includes a database storage unit that stores the hierarchically organized structure of objects and a set of terms, wherein each term from the set is assigned to at least one concept. Finally, the system includes a processor in communication with the database storage unit, the processor operable to identify a concept and a plurality of sub-concepts semantically depending from the concept in the hierarchically organized structure. The processor also applies a user-defined production rule to all terms assigned to the concept. In response to applying the user-defined production rule to all terms assigned to the concept, the processor automatically applies the user-defined production rule to the plurality of sub-concepts semantically depending from the concept.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE FIGURES

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1A is an example of a fragment of a business taxonomy containing business entities and their properties.

FIG. 1B is an example of a fragment of a business taxonomy containing concepts with applied production rules, according to an embodiment of the invention.

FIG. 2 is a flow diagram of an embodiment for rule-based assignment of terms to concepts.

FIG. 3 is a schematic diagram of an example of a generic computer system, according to an embodiment of the invention.

### DETAILED DESCRIPTION

Embodiments of the invention relate to methods and systems for rule-based assignment of terms to concepts. A single concept may have multiple terms to name it. Terms used to name a concept are assigned to this concept, generally with additional information on the context under which the term is used for the concept.

In conceptualizations of broad domains such as WordNet®, a lexical database from the Princeton University, or OpenCyc®, the open source version of the Cyc® database, the assignment of terms to concepts is performed manually. In case a limited domain has to be conceptualized in details, for example, to describe semantically all entities in a software system, the concepts that have to be used become very specific. Particularly, for most of them there are no basic terms in common language to name them. Instead, specifically created multi-term expressions are used. Moreover, the specific relations between terms are reflected by adding qualifying prefixes. Thus, a single term may occur in many expressions naming different (although semantically related) concepts. Whenever an additional term is added to synonymously name a concept, many other concepts also need to add a synonymous name. The resulting redundancy is a source of inconsistency and creates a lot of manual work in case the assignment of terms to concepts was done by hand.

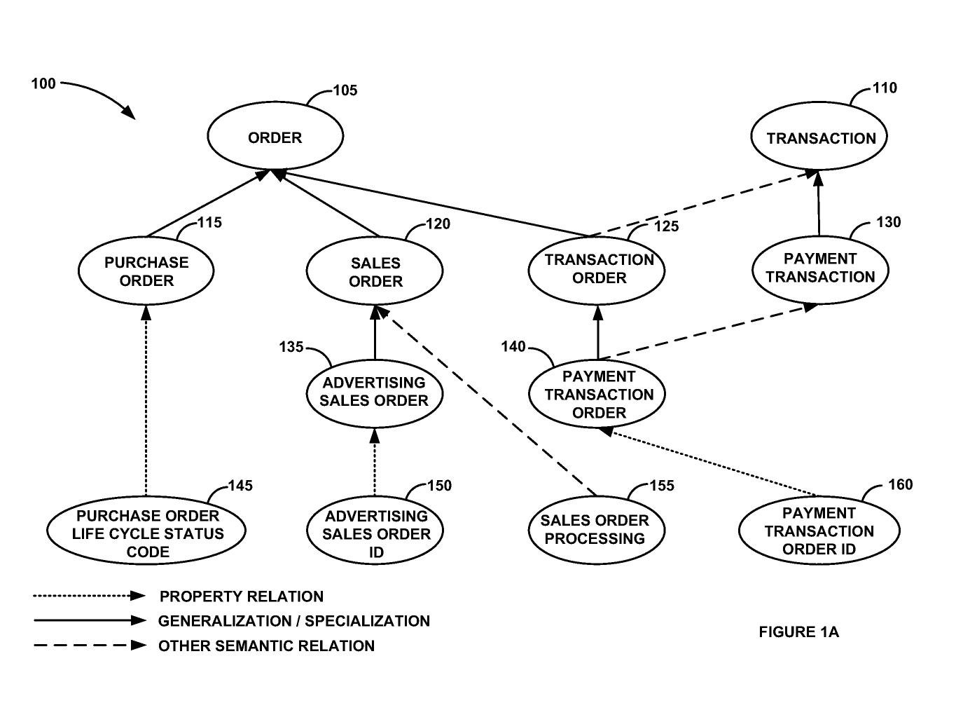

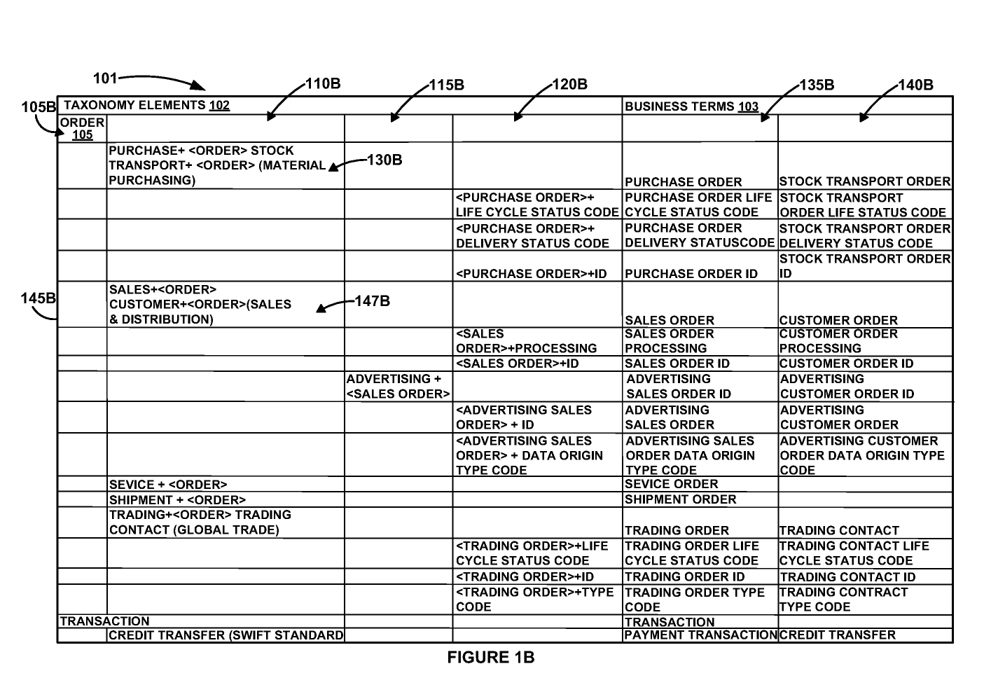

FIG. 1A is an example of a fragment of a business taxonomy containing business entities and their properties. The term “taxonomy” herein refers to the conceptualization of a domain. It should be noted that the conceptualizations are not limited to taxonomies only; in another embodiment, the conceptualization may concern ontologies, for example. FIG. 1A shows a typical example of a hierarchical taxonomy structure to be used to describe all entities of a software system—from objects to individual data elements of these objects. In an embodiment, the taxonomy structure may include a set of operations to be performed on the objects of the software system as well. Often times, a taxonomy describing a software system with all entities and properties it consists of may reach thousands of concepts.

Taxonomy 100 represents a hierarchical structure of semantically depending concepts. Taxonomy 100 includes top-level concepts Order 105 and Transaction 110. Concept 105 includes a number of sub-concepts including, but not limited to, Purchase Order 115, Sales Order 120, and Transaction Order 125. Generally, the child concepts of a given parent concept in the structure are specializations of this parent concept, which is listed as the last concept before the child concepts. For example, Purchase Order 115 is semantically dependent from Order 105; moreover, Purchase Order 115 specifies Order 105 as a purchase order. Transaction concept 110 includes Payment Transaction 130 sub-concept. Some of the sub-concepts may be further specified with their own sub-concepts. For example, Advertising Sales Order 135 is a sub-concept of Sales Order 120 and further characterizes Order 105 as an advertising sales order. Similarly, Payment Transaction Order 140 is a sub-concept of Transaction Order 125 and further specifies Order 105 as a payment transaction order.

In an embodiment, some of the sub-concepts may represent properties of the business entities described with upper-level concepts. For example, Taxonomy 100 includes sub-concepts Purchase Order Life Cycle Status Code 145, Advertising Sales Order ID 150, and Payment Transaction Order ID 160, which represent properties of Purchase Order 115, Advertising Sales Order 135, and Payment Transaction Order 140, correspondingly. In an embodiment, some of the sub-concepts may have specific relations to their upper-level concepts, different from specialization relation or property relation. For example, Sales Order Processing 155 and Sales Order 120: the relation is (Sales Order Processing 155) (has processing object) (Sales Order 120). Sales Order Processing 155 is a specialization of the more general concept Processing and a specific relation (has processing object) for Processing can be defined. There is a generic rule on how to define and name a specialization of a property, whenever an instantiation of this property is specified.

FIG. 1B is an example of a fragment of a business taxonomy containing concepts with applied production rules, according to an embodiment of the invention. Table 101 represents a taxonomy hierarchical structure in accordance with taxonomy 100 of FIG. 1A. The hierarchy of the taxonomy is with horizontal direction, this is, the levels of the hierarchy are directed horizontally. A set of production rules were applied to the concepts of taxonomy 100. The left side of FIG. 1B, Taxonomy Elements 102, shows the concepts from the taxonomy, while the right side, Business Terms 103, shows the actual terms assigned to the concepts. The Taxonomy Elements 102 contains a number of columns including columns 105B, 110B, 115B, and 120B. These columns include concepts from the taxonomy. The elements of columns 105B, 110B, and 115B are business entities, while the elements of column 120B are properties of the business entities. The concepts are organized by semantic dependencies. For example, concepts from column 110B are semantically dependent from concepts from column 105B, while concepts from column 115B are semantically dependent from concepts from column 110B. Thus, Taxonomy Elements 102 forms a hierarchical structure of concepts with a number of levels defined by the semantic dependencies between the concepts.

Business Elements 103 contains a number of columns including columns 135B and 140B. Columns 135B and 140B contain the actual terms that are assigned to the concepts from Taxonomy Elements 102. In the current example, there are at most two terms assigned per concept; however, there is no limitation in the number of terms which could be assigned to a single concept.

In taxonomies, the entities containing very specific details can be named only with multi-term expressions. The multi-term expressions may be formed from names of concepts, which depend semantically from other concepts, containing the less dependent concept's name as part of the expression. For example, the multi-term expression “purchase order” contains the generalizing concept “order” as part of the expression. The more general a concept is, the less dependent it is.

To avoid redundancy causing potential incompleteness and high amount of manual work, the manual assignment of individual terms to concepts may be replaced by applying production rules to the concepts of a taxonomy. A production rule consists of a body representing a logical rule and a head representing terms produced by the logical rule. In FIG. 1B, the concepts are formed with the rule: concept=<term₁>+ . . . +<termₙ>, where “concept” is the head of the production rule, viewed as a placeholder for the produced concepts; and “<term₁>+ . . . +<termₙ>” is the body, logical rule, of the production rule. Each <termᵢ> in the logical rule is either a constant or a variable to be instantiated by the terms of another concept, which concept is of lower dependency level in the taxonomy structure. It should be appreciated that the production rules to be applied on the concepts are created according to the structure of concepts describing a particular domain. The production rules may vary for different taxonomies. In addition, the rules may be created from a user or from a computer program executing instructions, or from a combination of both, user direction and computer program. In an embodiment, context information can be assigned to a rule and thus to limit rule's validity to this context only. Outside that context, the rule is not to be applied for assigning terms to the concept.

Referring back to FIG. 1B, each line in columns 105B, 110B, 115B, and 120B represents a production rule. For example, Purchase+<Order> 130B represents a production rule including terms separated by “+”. The “Purchase” term is a constant. A constant corresponds to a simple assignment of a term to a concept. The term “<Order>” represents a variable to be instantiated with all terms for “Order” (e.g., Order 105) corresponding to an entry of Business Terms 103 (e.g., Order 105B). In an embodiment, the entries of Business Terms 103 may be unique for each concept of the taxonomy. In the current example, the concept Order 105 is a constant and only one term, Order 105B, is assigned to it.

In an embodiment, a number of alternative terms may be assigned to a concept. In this case, a production rule has to be applied on all of the alternative terms. For example, concept 145B of FIG. 1B includes two alternative terms—Sales Order and Customer Order. Two rules were applied to the terms: 1) “Sales+<Order>”—that specifies that constant “Sales” and variable “Order” to be instantiated with all terms for concept “Order”; and 2) “Customer+<Order> (Sales and Distribution)”—constant “Customer” and variable “Order” to be instantiated with all terms for concept “Order”. In addition, context information is assigned to this rule limiting the validity of the rule to the context of Sales and Distribution. This means that the terms produced by this rule are only to be used for naming the concept in this context. Since the variable in both rules refers to the concept Order 105, which is assigned to a single term, these rules produce each a single term—“Sales Order” and “Customer Order”. However, Sale Order Processing 150B concept, that is dependent from the Sales Order 120 concept, has a single rule: “<Sale Order>+Processing”—variable “Sales Order” and constant “Processing”. As the variable “Sales Order” can be instantiated with both terms assigned to the concept Sales Order 120, “Sales Order” and “Customer Order”, this results in two term assignments for concept “Sales Order Processing”—“Sales Order Processing” and “Customer Order Processing” terms.

Referring to another concept in a rule defines a semantic relation between the concept the rule is assigned to and the concept the rule refers to. This relation should define a strict order to avoid semantic circles and thus infinite loops in the assignment process. The most common semantic relation exploited to define a rule is specialization of a concept (usually done by adding a new term in front of the name of the more general one). Such a relation results in a rule with a single variable of the form: “Constant”+<General_Concept>. This is also valid for production rules resulting from part/whole relations, as in the case of column 120B concepts. In another embodiment, several variables can appear in a rule exploiting different semantic relations. For example, a rule in the form of: “<Concept>+<General_Concept>”. In case there are several variables in a rule, the number of terms produced by the rule is the number of instantiations possible for each variable (which can depend on the context).

Generally, the context assignments to the rules are inherited. For example, the second rule for concept Sales Order 120 is limited to be used in context “Sales and Distribution”; outside this context, there is only one term assigned to the concept “Sales Order”. This means that outside this context, the single rule assigned to concept “Sales Order Processing” also produces just a single term and thus only one term is assigned there to the concept.

While in English multi-term expressions are used for concepts that are too specific for having a single term in natural language, in other languages constructs of terms may be used. For example, in German language multiple terms can be merged into a single term, for example the term “Verkaufsauftragsabwicklung” is merged from “Verkauf”, “Auftrag”, and “Abwicklung”. However, such constructs follow specific grammatical rules which can be added as production rules to produce terms from the corresponding grammatical rules. Therefore, the usage of production rules on concepts is not limited to languages using multi-term expressions but can equally be well applied to other languages.

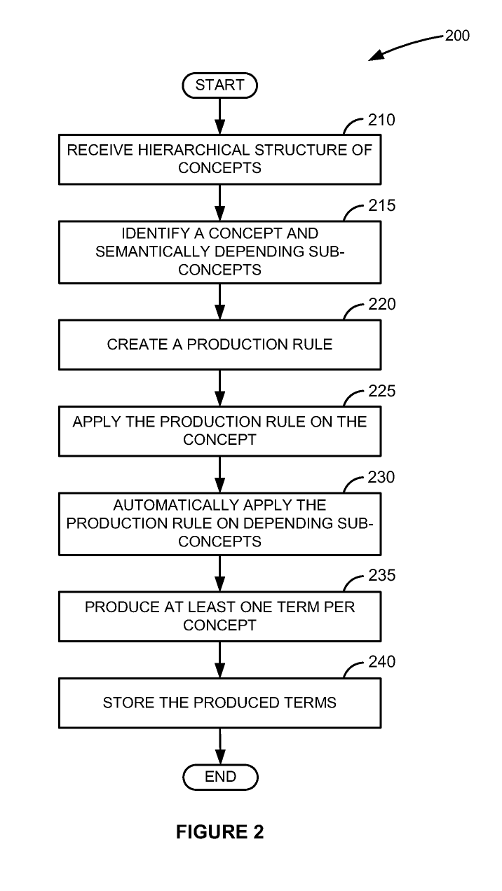

FIG. 2 is a flow diagram of an embodiment for rule-based assignment of terms to concepts. At block 210, an entity model is received. The entity model represents a hierarchical structure of concepts and the relationships between these concepts such as ontology, taxonomy, and so on. At block 215, top-level entities of the entity model are identified. A plurality of sub-entities semantically depending from the top-level entities is also identified. At block 220, a production rule is created. The production rule consists of a body representing a logical rule and a head representing terms produced by the logical rule. In addition, the production rule may include context information limiting the validity of the rule to a specific context. At block 225, the production rule is applied to the top-level entities of the entity model. In response to applying the production rule to the top-level entities, the production rule is automatically applied on the plurality of sub-entities semantically depending from the top-level entities, at block 230. Thus, with changing the top-level entity, all depending entities will be changed as well. At block 235, at least one term is produced per each concept in response to applying the production rules on the concepts. At block 240, the produced terms are stored in a database storage unit.

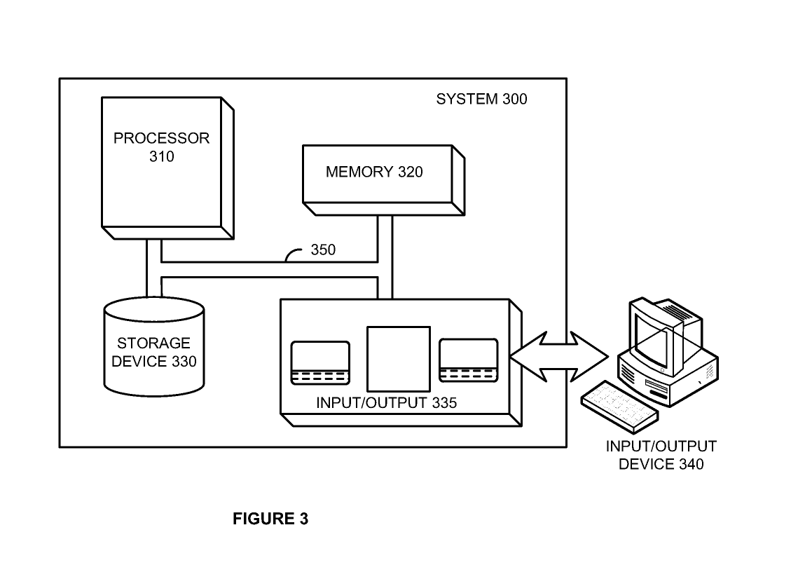

FIG. 3 is a schematic diagram of an example of a generic computer system, according to an embodiment of the invention. Computer system 500 can be used for the operations described in association with the FIG. 1 according to one implementation. System 300 includes a processor 310, a memory 320, a storage device 330, and an input/output device 340. Each of the components 310, 320, 330, and 340 are interconnected using a system bus 350.

The processor 310 is capable of processing instructions for execution within the system 300. The processor is in communication with the storage unit 330. Further, the processor is operable to identify a concept and a plurality of sub-concepts semantically depending from the concept in the hierarchically organized structure, apply a user-defined production rule to all terms assigned to the concept, and automatically apply the user-defined production rule to the plurality of sub-concepts semantically depending from the concept. In one embodiment, the processor 310 is a single-threaded processor. In another embodiment, the processor 310 is a multi-threaded processor. The processor 310 is capable of processing instructions stored in the memory 320 or on the storage device 330, to display graphical information for a user interface on the input/output device 340.

The storage device 330 is capable of providing mass storage for the system 300. The storage device 330 stores the hierarchically organized structure of concepts and the set of terms produced by the logical rule. In one implementation, the storage device 330 is a computer-readable medium. In alternative implementations, the storage device 330 may be a floppy disk device, a hard disk device, an optical disk device, or a tape device.

The input/output device 340 provides input/output operations 335 for the system 300. In one implementation, the input/output device 540 includes a keyboard and/or pointing device. In another implementation, input/output device 540 includes a display unit for displaying graphical user interfaces.

Elements of embodiments may also be provided as a tangible machine-readable medium (e.g., computer-readable medium) for tangibly storing the machine-executable instructions. The tangible machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions. For example, embodiments of the invention may be downloaded as a computer program, which may be transferred from a remote computer (e.g., a server) to a requesting computer (e.g., a client) via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A computer-readable storage medium tangibly storing machine-readable instructions thereon, which when executed by the machine, cause the machine to perform operations comprising:
receiving a hierarchically organized structure of concepts wherein one or more of the concepts in the hierarchically organized structure are correspondingly assigned to at least one term;
identifying at least one of the concepts in the hierarchically organized structure and a plurality of sub-concepts semantically depending from the identified concept;
creating a production rule comprising a head and a body, the body representing a logical rule and the head representing a set of terms produced by the logical rule; and
applying the production rule to at least some of the terms assigned to the concept.

2. The computer-readable storage medium of claim 1 wherein the operations further comprise:
in response to applying the production rule to at least some of the terms assigned to the concept, automatically applying the production rule to the plurality of sub-concepts semantically depending from the concept.

3. The computer-readable storage medium of claim 1, wherein the logical rule includes at least one element selected from the group consisting of a constant, a variable, and a combination of a constant and a variable.

4. The computer-readable storage medium of claim 3, wherein the constant corresponds to a simple assignment of a term to the concept.

5. The computer-readable storage medium of claim 3, wherein the variable is instantiated by a set of terms assigned to a second concept, wherein the second concept is of a lower dependency level in the hierarchically organized structure of concepts.

6. The computer-readable storage medium of claim 1, wherein the production rule includes context information that specifies at least one context in which the production rule is valid.

7. The computer-readable storage medium of claim 6, wherein concepts of the hierarchically organized structure represent a business entity, a business entity property, or a business entity operation.

8. A computer implemented method comprising:
receiving a hierarchically organized structure of concepts, wherein one or more of the concepts in the hierarchically organized structure are correspondingly assigned to at least one term;
identifying at least one of the concepts in the hierarchically organized structure and a plurality of sub-concepts semantically depending from the identified concept;
creating a production rule comprising a head and a body, the body representing a logical rule and the head representing a set of terms produced by the logical rule; and
applying the production rule to at least some of the terms associated with the identified concept.

9. The method of claim 8 further comprising:
in response to applying the production rule to the at least some of the terms associated with the concept, automatically applying the production rule to the plurality of sub-concepts semantically depending from the concept.

10. The method of claim 8, wherein the logical rule includes at least one element selected from the group consisting of a constant, a variable, and a combination of a constant and a variable.

11. The method of claim 10, wherein the constant corresponds to a simple assignment of a term to the concept.

12. The method of claim 10, wherein the variable is to be instantiated by a set of terms assigned to a second concept, wherein the second concept is of a lower dependency level in the hierarchically organized structure of concepts.

13. The method of claim 8, wherein the production rule includes context information that specifies a context in which the production rule is valid.

14. The method of claim 13, wherein each concept of the hierarchically organized structure represents a business entity, a business entity property, or a business entity operation.

15. A computing system comprising:
a database storage unit that stores a hierarchically organized structure of objects and a set of terms wherein each term from the set is assigned to at least one concept; and
a processor in communication with the database storage unit, the processor operable to identify a concept and a plurality of sub-concepts semantically depending from the identified concept in the hierarchically organized structure, apply a user-defined production rule to all terms assigned to the concept, and automatically apply the user-defined production rule to the plurality of sub-concepts semantically depending from the concept.

16. The system of claim 15, wherein the production rule consists of a head and a body, the body representing a logical rule and the head representing a set of terms produced by the logical rule.

17. The system of claim 16, wherein the logical rule includes at least one element selected from the group consisting of a constant, a variable, and a combination of a constant and a variable.

18. The system of claim 17, wherein the variable is to be instantiated by a set of terms assigned to a second concept, wherein the second concept is of a lower dependency level in the hierarchically organized structure of concepts.

19. The system of claim 15, wherein the production rule includes context information that specifies a context in which the production rule is valid.

20. The system of claim 15, wherein each object of the hierarchically organized structure represents a business entity, a business entity property, or a business entity operation.
